(19) United States
(12) Patent Application Publication
(10) Pub. No.: US 2020/0367515 A1
(43) Pub. Date: Nov. 26, 2020

(54) OUTER WRAPPER FOR ROLLED FOOD, ROLLED FOOD, AND METHOD FOR PRODUCING THE SAME

(71) Applicant: NICHIREI FOODS INC., Tokyo (JP)

(72) Inventors: Kosuke FUKUJU, Chiba-shi (JP); Yuki SHIMIZU, Chiba-shi (JP); Aya TOMIMOTO, Chiba-shi (JP); Ayako NAGASAKA, Chiba-shi (JP)

(73) Assignee: NICHIREI FOODS INC., Tokyo (JP)

(21) Appl. No.: 16/988,267

(22) Filed: Aug. 7, 2020

Related U.S. Application Data
(63) Continuation-in-part of application No. PCT/JP2019/004672, filed on Feb. 8, 2019.

(30) Foreign Application Priority Data
Feb. 9, 2018 (JP) 2018-022522

(51) Int. Cl. A21D 13/32; A21D 13/60; A21D 6/00; A23P 20/25

(52) U.S. Cl. CPC A21D 13/32; A23P 20/25; A21D 6/001; A21D 13/60

(57) ABSTRACT

This invention provides a rolled food that maintains a crispy texture characteristic of a rolled food immediately after deep frying for several hours after deep frying and a method for producing the same. This invention also provides an outer wrapper for a rolled food, such as a spring roll, in which a degree of polymerization of a gluten protein in the outer wrapper baked before rolling is 32.00% or higher and the breaking strength measured using a creep meter under specific conditions is 4.30 N or higher. Further, this invention provides a rolled food prepared with the use of such outer wrapper and a method for producing such outer wrapper and rolled food.

### CROSS REFERENCE TO RELATED APPLICATIONS

This application is a Continuation-in-Part of PCT International Application No. PCT/JP2019/004672, filed on Feb. 8, 2019, which claims priority under 35 U.S.C. 119(a) to Patent Application No. 2018-022522, filed in Japan on Feb. 9, 2018, all of which are hereby expressly incorporated by reference into the present application.

### TECHNICAL FIELD

The present invention relates to an outer wrapper for a rolled food, such as a spring roll, a rolled food using such outer wrapper, and a method for producing the same.

### BACKGROUND ART

Rolled foods are classified into foods comprising fillings wrapped in outer wrappers, such as spring rolls, burritos, tacos, and crapes, and foods consisting of rolled outer wrappers without fillings, such as cigarette-shaped cookies. For example, outer wrappers of spring rolls (i.e., spring roll wrappers) are generally produced by baking a paste raw material mainly composed of cereal powder, such as flour, on a heating drum of an apparatus for forming spring roll wrappers. Fried spring rolls are produced by placing fillings on the baked spring roll wrappers, and rolling up the wrappers, followed by deep frying. Fried spring rolls are desired to have a “crispy texture” that is characteristic of spring rolls immediately after deep frying. When conventional spring rolls are deep fried and sold in packages remaining warm or on open trays, however, spring rolls disadvantageously absorb water vapor in the packages or moisture contents of fillings several hours later. When such spring rolls are eaten without any processing or heated in a microwave oven, accordingly, a “crispy texture” characteristic of spring rolls immediately after deep frying was deteriorated to a significant extent.

To date, various methods for suppressing deterioration in spring roll textures with the elapse of time had been proposed. Examples of such various methods include: modification of flour or starch as a raw material of spring roll wrapper dough; addition of enzyme to a raw material of spring roll wrapper dough; and coating of the surface of the heating drum in the step of baking or the surface of the baked dough with fat and oil. Various methods for incorporating particular fillings into the spring roll wrapper dough before baking have been reported. Examples include: a method of incorporating fat and oil with a melting point of 50° C. to 90° C. into the rolled wheat flour dough in an amount of 1% to 15% (Patent Document 1); a method of adding a swelling agent to a raw material of spring roll wrapper dough (Patent Document 2); and a method of incorporating carbon dioxide or other gas into spring roll wrapper dough (Patent Document 3). However, conventional techniques were not sufficient to maintain a “crispy texture” characteristic of spring rolls immediately after deep frying for several hours.

### PRIOR ART DOCUMENTS

### Patent Documents

[Patent Document 1] JP Patent No. 2,762,116
[Patent Document 2] JP 2010-187561 A
[Patent Document 2] JP 2015-6152 A

### SUMMARY OF THE INVENTION

### Objects to Be Attained by the Invention

An object of the present invention is to provide a rolled food that maintains a crispy texture characteristic of a rolled food immediately after deep frying for several hours after deep frying and a method for producing the same.

### Means for Attaining the Objects

The present inventors have conducted concentrated studies in order to attain the above objects. As a result, they discovered a correlation between the degree of polymerization and the breaking strength of a gluten protein in an outer wrapper for a rolled food and a crispy texture. Specifically, they discovered that a rolled food produced with the use of an outer wrapper comprising a gluten protein with a given level or higher degree of polymerization and breaking strength would maintain a crispy texture characteristic of a rolled food immediately after deep frying for several hours after packaging or other processing. This has led to the completion of the present invention.

Specifically, the present invention includes the following.

[1] An outer wrapper for a rolled food baked before rolling, having the features (A) and (B):
(A) a gluten protein in the outer wrapper has a degree of polymerization of 32.00% or higher; and
(B) an outer wrapper composed of 8 sheets each having a size of 3 cm×4.5 cm stacked on one another exhibits a breaking strength of 4.30 N or higher, which is measured using a creep meter with a wedge plunger (width: 2 cm) at a moving speed of 60 mm/min and a penetration distance of 13 mm.
[2] The outer wrapper for the rolled food according to [1], further having the feature (C):
(C) an outer wrapper composed of 2 sheets each having a size of 1.5 cm×5 cm stacked on each other exhibits a tensile strength of 0.34 N or higher, which is measured using a creep meter at a moving speed of 120 mm/min and a moving distance of 25 mm in the extension direction.
[3] The outer wrapper for the rolled food according to [1] or [2], wherein the rolled food is a spring roll and the outer wrapper is a spring roll wrapper.
[4] A rolled food comprising fillings wrapped in the outer wrapper for the rolled food according to any of [1] to [3].
[5] The rolled food according to [4], which is deep-fried.
[6] The rolled food according to [4] or [5], which is frozen.
[7] The rolled food according to any of [4] to [6], wherein the rolled food is a spring roll and the outer wrapper is a spring roll wrapper.
[8] A method for producing an outer wrapper for a rolled food comprising the following steps:
(1) a step of adding water and salt to a powdery raw material mainly composed of wheat flour and kneading the mixture to prepare a dough;
(2) a step of adding water to the dough to prepare a batter; and
(3) a step of baking the batter.
[9] The method for producing an outer wrapper for a rolled food according to [8], wherein the rolled food is a spring roll and the outer wrapper is a spring roll wrapper.
[10] A method for producing a rolled food comprising a step of placing fillings on the outer wrapper for the rolled food obtained by the method according to [8] or [9] and rolling up the outer wrapper to form a rolled food.
[11] The method for producing a rolled food according to [10], which further comprises a step of deep frying.
[12] The method for producing a rolled food according to [10] or [11], which further comprises a step of freezing.
[13] The method for producing a rolled food according to any of [10] to [12], wherein the rolled food is a spring roll and the outer wrapper is a spring roll wrapper.

This patent application claims priority from Japanese Patent Application No. 2018-22522 filed on Feb. 9, 2018, and it includes part or all of the contents as disclosed in the description thereof.

### Effects of the Invention

A strong gluten network is formed in the outer wrapper for the rolled food of the present invention. In a rolled food using such outer wrapper, accordingly, moisture transfer from fillings is suppressed, and a crispy texture immediately after deep frying is maintained for several hours after deep frying and packaging or other processing. In the case of a rolled food using a conventional outer wrapper, use of a food material containing cereal powder was necessary between the outer wrapper and fillings in order to maintain a crispy texture immediately after deep frying. With the use of the outer wrapper for the rolled food of the present invention, however, a rolled food that maintains crispness of the outer wrapper for several hours after storage can be obtained with the use of a decreased amount of such food material or without the use thereof. In addition, flouriness and oiliness caused with the use of such food material can be improved.

### BRIEF DESCRIPTION OF THE DRAWINGS

FIG. 1 shows a comparison of a degree of polymerization of a gluten protein in the spring roll wrappers of Examples 1 to 3 (the products of the present invention) and of Comparative Example 1 (the conventional product).

FIG. 2 shows a comparison of breaking strength of the spring roll wrappers of Examples 1 to 3 (the products of the present invention) and of Comparative Example 1 (the conventional product).

FIG. 3 shows a comparison of tensile strength of the spring roll wrappers of Examples 1 to 3 (the products of the present invention) and of Comparative Example 1 (the conventional product) (*: by the t-test assuming equal variance).

### EMBODIMENTS OF THE INVENTION

Hereafter, the present invention is described in detail.

1. An outer wrapper for a rolled food and a rolled food

The outer wrapper for the rolled food of the present invention is a sheet-like skin used for wrapping fillings of a rolled food, and a gluten protein in the outer wrapper baked before rolling has a given level or higher degree of polymerization and breaking strength.

In the present invention, the term “rolled food” refers to a food comprising fillings and an outer wrapper wrapping the fillings. Examples thereof include spring rolls, burritos, tacos, crapes, pies, pierogi, Ravioli, pita, Falafel, steamed dumplings, and Gyoza dumplings. A configuration of the “rolled food” of the present invention is not particularly limited, provided that fillings are wrapped in an outer wrapper. For example, the entire fillings may be wrapped and enclosed in an outer wrapper, or a part of fillings may be exposed. When a rolled food is a spring roll, for example, fillings of interest are placed on a wrapper, and the wrapper is rolled up to form a rolled food in accordance with a conventional technique. The term “rolled food” used in the present invention refers to both a rolled food before deep frying and a rolled food after deep frying. Also, the “rolled food” of the present invention encompasses a frozen form. A rolled food before deep frying and a rolled food after deep frying can be stored or distributed under freezing conditions. A freezing temperature is preferably from −40° C. to −18° C. A frozen rolled food can be subjected to deep frying remaining frozen or after thawing.

The outer wrapper for the rolled food of the present invention is baked before rolling, and the baked outer wrapper has the features (A) and (B).

(A) A degree of polymerization of a gluten protein

The “degree of polymerization of a gluten protein” in the present invention is a physical property value indicating the strength of the gluten network in an outer wrapper for a rolled food, and it is correlated with effects of suppressing moisture transfer from fillings. The degree of polymerization of a gluten protein can be determined by extracting a protein with the use of a mercaptoethanol (ME)-containing protein extraction buffer (+ME) and a ME-free protein extraction buffer (−ME) and calculating the degree of polymerization based on the amount of the protein quantified using an ME-containing extraction buffer (i.e., the (+ME) protein) and the amount of the protein quantified using an ME-free extraction buffer (i.e., the (−ME) protein) in accordance with the following equation.

Degree of polymerization (%)=((+ME)protein−(−ME)protein)/(+ME)protein×100

Specifically, the (+ME) protein and the (−ME) protein may be quantified in accordance with the method described below.

A sample (100 mg, the baked outer wrapper for a rolled food) was introduced into each of two 2-mL Eppendorf tubes, 1 mL of an ME-free protein extraction buffer (−ME) (composition: 10 mL of 5% SDS solution, 10 mL of 0.5 M Tris-HCl buffer (pH 6.8), and 80 mL of distilled water) was added to a first tube, 1 mL of an ME-containing protein extraction buffer (+ME) (composition: 10 mL of 5% SDS solution, 10 mL of 0.5 M Tris-HCl buffer (pH 6.8), 1 mL of ME, and 79 mL of distilled water) was added to a second tube, and the contents of the tubes were mixed using a vortex mixer until the contents were completely dissolved. Thereafter, the tubes were agitated in an agitator (about 2,000 rpm) for 1 hour and centrifuged at 6,200 rpm and room temperature for 10 minutes. The supernatants were then transferred to other Eppendorf tubes, and the amount of the proteins in the solutions was measured by the Lowry method using the RCDC protein assay kit (Bio-Rad).

As “the degree of polymerization of a gluten protein” is increased, the gluten network becomes strengthened. This indicates an excellent “crispy texture.” In the outer wrapper for the rolled food of the present invention, a degree of polymerization of a gluten protein is 32.00% or higher, preferably 37.00% or higher, and more preferably 41.00% or higher. When the degree of polymerization of the gluten protein in the outer wrapper is lower than 32.00%, the gluten network is weak, a moisture barrier becomes insufficient, and a crispy texture immediately after deep frying (i.e., crispness) is not maintained. When the degree of polymerization of the gluten protein in the outer wrapper is higher than 55.00%, other textures are adversely affected (e.g., the food becomes difficult to bite through), and the whole quality of the rolled food becomes deteriorated. Thus, the degree of polymerization that is higher than 55.00% is not preferable. The term “crispness” used herein refers to a pleasant crispy texture.

### (B) Breaking Strength

In the present invention, the “breaking strength” is an indicator of physical hardness of an outer wrapper for a rolled food, and it can be indicated in terms of the maximal load (N) measured using a creep meter (plunger form: a wedge form assuming biting through with the front teeth) under particular conditions. A higher “breaking strength” value is considered to lead to an enhanced “crispy texture” of an outer wrapper for a rolled food after deep frying. The baked outer wrapper for the rolled food of the present invention composed of 8 sheets each having a size of 3 cm×4.5 cm stacked on one another (thickness of each sheet: 0.5 mm to 0.7 mm, the total thickness of the stacked 8 sheets: 4.0 mm to 5.6 mm) exhibits a breaking strength (the maximal load) of 4.30 N or higher, preferably 4.45 N or higher, and more preferably 4.50 N or higher, which is measured using a creep meter with a wedge plunger (width: 2 cm) at a moving speed of 60 mm/min and an penetration distance of 13 mm. When the breaking strength is lower than 4.30 N, a crispy texture immediately after deep frying cannot be felt when it is bitten. In contrast, the breaking strength that is higher than 6.00 N is not preferable since the wrapper is less likely to brake when it is bitten. Any creep meter that is commonly used for evaluation of physical properties concerning a food texture can be used for measurement of the breaking strength without particular limitation. For example, a creep meter CR-200D (Sun Scientific Co., Ltd.) and a creep meter RE2-33005C (Yamaden Co., Ltd.) can be used. The breaking strength is measured under the condition that temperature is about 25° C. (room temperature) and relative humidity is about 57%.

Concerning the outer wrapper for the rolled food of the present invention, the outer wrapper baked before rolling further has the following feature (C).

### (C) Tensile Strength

In the present invention, the “tensile strength” is a physical property value indicating the strength of the gluten network of an outer wrapper for a rolled food, and it can be indicated in terms of the maximal tensile load (N) measured using a creep meter (adaptor form: for tensile measurement assuming biting through with the front teeth) under particular conditions. A higher “tensile strength” value is considered to lead to an enhanced “crispy texture” of an outer wrapper for a rolled food after deep frying. The baked outer wrapper for the rolled food of the present invention composed of 2 sheets each having a size of 1.5 cm×5 cm stacked on each other exhibits a tensile strength (the maximal tensile load) of 0.34 N or higher, preferably 0.39 N or higher, and more preferably 0.44 N or higher, which is measured using a creep meter at a moving speed of 120 mm/min and a moving distance of 25 mm in the extension direction. When the tensile strength is lower than 0.34 N, a crispy texture immediately after deep frying cannot be felt when it is bitten. In contrast, the tensile strength that is higher than 2.00 N is not preferable since the wrapper is less likely to brake when it is bitten. Any creep meter that is commonly used for evaluation of physical properties concerning a food texture can be used without particular limitation. For example, a creep meter CR-200D (Sun Scientific Co., Ltd.) and a creep meter RE2-33005C (Yamaden Co., Ltd.) can be used. The tensile strength is measured under the condition that temperature is about 25° C. (room temperature) and relative humidity is about 57%.

### 2. A Method for Producing an Outer Wrapper for a Rolled Food and a Rolled Food

The method for producing the outer wrapper for the rolled food of the present invention comprises: (1) a step of adding water and salt to a powdery raw material mainly composed of wheat flour and kneading the mixture to prepare a dough; (2) a step of adding water to the dough to prepare a batter; and (3) a step of baking the batter. The method for producing the outer wrapper for the rolled food of the present invention comprises: Step (1) of adding water to a powdery raw material mainly composed of wheat flour and kneading the mixture to prepare a dough; and Step (2) of adding water to the dough to prepare a batter.

In the present invention, the “dough” prepared in Step (1) is a viscoelastic mass prepared by adding water to a powdery raw material mainly composed of wheat flour and kneading the mixture. The amount of water used is preferably 50% to 60% by weight based on the powdery raw material. When the amount of water is less than 50% by weight, the dough becomes hardened, and it is difficult to prepare a batter with the addition of water. When the amount of water is more than 60% by weight, the dough becomes too soft to hold together. Thus, the amount of water outside the aforementioned range is not preferable since adequacy of a machine such as a mixer is deteriorated.

A raw material of the outer wrapper for the rolled food of the present invention may contain a powdery raw material, water, and salt, and a raw material used for a general rolled food can be used. A powdery raw material may contain cereal powder as a main raw material. Examples of cereal powder include wheat flour, barley flour, rye flour, rice flour, buckwheat flour, corn flour, coix seed powder, Japanese millet powder, and foxtail millet powder, with wheat flour being preferable. In general, wheat flour preferably consists of all-purpose flour or it is mainly composed of an all-purpose flour mixture comprising all-purpose flour and at least one of hard flour, semi-hard flour, and soft flour. Any of such cereal powder can be used alone or two or more thereof can be used in combination.

In the present invention, the “batter” prepared in Step (2) is a liquid dough prepared with the addition of water to the massive dough obtained in Step (1). When wheat flour is used as cereal powder, the amount of wheat flour is preferably 30% to 60% by weight based on the batter. When the amount is less than 30% by weight, the batter cannot be evenly applied on a baking drum because of excessively low viscosity. The amount exceeding 60% by weight is not preferable because viscosity is increased, and an even thin wrapper cannot be obtained. The wrapper obtained by baking the batter in Step (3) before rolling is referred to as “an outer wrapper for a rolled food.”

A powdery raw material may further contain starch, proteins, and other materials. Examples of starch include tapioca starch, potato starch, corn starch, waxy corn starch, wheat starch, rice starch, and processed starch obtained by subjecting the aforementioned starch to treatment such as pregelatinization, etherification, esterification, acetylation, cross-linking, or oxidation. Examples of proteins include wheat-derived gluten, soybean-derived vegetable proteins, egg-derived animal proteins, and a mixture thereof. Other materials are not particularly limited, provided that the effects of the present invention are not lost or such other materials provide the effects of the present invention or other effects (e.g., improvement in wrapper hue or luster or improvement in dispersibility of the powdery raw material in water). Examples include dextrin, saccharide, amino acid, or salt thereof (e.g., glutamic acid, sodium glutamate, and glycine), fat and oil (e.g., vegetable oil, such as soybean oil, rapeseed oil, olive oil, palm oil, and hydrogenated oil thereof; and animal fat and oil, such as lard and beef tallow), dietary fiber (e.g., corn husk, wheat bran, barley bran, rice bran, dietary fiber mainly composed of cellulose, hemicellulose, lignin, or pectin in starch contained in corn, potato, wheat, barley, and rice, and a degradation product thereof), egg, milk, amino acid (e.g., alanine, glycine, and lysine), a polysaccharide thickener (e.g., xanthan gum, Locust bean gum, gellan gum, guar gum, and carragheenan), and an emulsifier (e.g., fatty acid ester of glycerin, such as organic acid monoglyceride, monoglyceride, and polyglycerol ester, and sucrose fatty acid ester). The amount of cereal powder, starch, proteins, or other materials to be incorporated into the powdery raw material can be adequately determined in accordance with the purpose.

It is not necessary that all the raw materials of the dough are simultaneously mixed with water, and the raw materials can be separately mixed with water, provided that all the raw materials of the dough are homogeneously dispersed and suspended in water in the end.

In Step (3), the batter can be generally baked using a sheet-type or drum-type baking apparatus used for baking of a rolled food such as a spring roll wrapper. An adequate amount of the batter obtained in Step (2) is applied, heated, solidified, and cut into pieces of desired size. Thus, the batter of interest can be obtained. Adequate conventional baking conditions can be selected. For example, baking temperature is generally 90° C. to 160° C., and preferably 100° C. to 150° C. When temperature is lower than 90° C., the batter may not be sufficiently solidified. When temperature is higher than 160° C., the resulting wrapper becomes too hard to sufficiently roll up the fillings. Thus, the temperature outside the aforementioned range is not preferable. The baking time is generally 10 to 120 seconds, and preferably 15 to 45 seconds. When the time is shorter than 10 seconds, the batter may not be sufficiently solidified. When the time is longer than 120 seconds, the resulting wrapper becomes too hard to sufficiently roll up the fillings. Thus, the time outside the aforementioned range is not preferable.

The rolled food of the present invention can be produced in accordance with a conventional technique except for the use of the outer wrapper for the rolled food of the present invention. Any fillings that have heretofore been used for rolled foods can be used without particular limitation. Examples include meat or processed meat (e.g., beef, chicken, pork, ham, bacon, and sausage), seafood (e.g., shrimp, squid, octopus, Asari clam, and scallop), vegetables (e.g., onion, green bell pepper, carrot, bell pepper, and cabbage), various mushrooms (e.g., shimeji mushroom, siitake mushroom, mushroom, and maitake mushroom), beans (e.g., soybeans, split peas, lentils, and chickpeas), nuts and seeds (e.g., almonds, peanuts, and walnuts), bean starch vermicelli, fat and oil, starch, glue, seasonings, and species. Examples of fillings that can be used include fruits, such as apples, bananas, strawberries, kiwis, pineapples, and blueberries, and confectionaries, such as chocolate, jam, nuts, custard cream, and adzuki bean paste. A rolled food can be in the form of confectionery such as a galette or crape. Alternatively, fillings with a variety of taste, such as pizza-like fillings containing tomato-flavored vegetables and cheese or fillings containing curry-flavored vegetables and meats, can be used, and rolled foods with a new sensation can be prepared. A configuration or size of a rolled food, a time or temperature for deep frying, and other conditions may be determined in accordance with a conventional technique.

### EXAMPLES

Hereafter, the present invention is described in greater detail with reference to examples and comparative examples, although the present invention is not limited to these examples.

### (Example 1 and Comparative Example 1) Preparation of Spring Roll Wrappers and Spring Rolls

### (1) Preparation of Spring Roll Wrappers

The spring roll wrapper of Example 1 was prepared in accordance with Production method A and the spring roll wrapper of Comparative Example 1 was prepared in accordance with Production method B using the raw materials of spring roll wrapper dough in the amount (% by weight) shown in Table 1. Concerning the raw materials shown in Table 1, Kinsuzuran (Nisshin Flour Milling Co., Ltd.) was employed for wheat flour (all-purpose flour), Halodex (Hayashibara Corporation) was employed for starch syrup, soybean sirasimeyu (refined soybean oil) (J-Oil Mills, INC.) was employed for oil, Satellite® (NOF CORPORATION) was employed for emulsified fat and oil, salt (Nihonkaisui Co., Ltd.) was employed for salt, and Tops baking powder 540 (Okuno Chemical Industries Co., Ltd.) was employed for baking powder.

TABLE 1
Composition of spring roll wrapper

| Raw materials | Amount (wt %) |
|---|---|
| Wheat flour (all-purpose flour) | 43.82 |
| Starch syrup | 8.81 |
| Oil | 3.02 |
| Emulsified fat and oil | 0.26 |
| Salt | 0.76 |
| Baking powder | 0.51 |
| Water | 42.82 |
| Total | 100.00 |

### <Production Method A: The Method of the Present Invention>

Wheat flour (all-purpose flour, 75 kg), 1.29 kg of salt, and 0.87 kg of baking powder were introduced into a mixer (HM300-140T, Oshikiri Machinery Ltd.) and mixed at low speed. To the resulting mixture, 42.17 kg of water and 8.31 kg of starch syrup were added, and the mixture was further mixed for 3 minutes at low speed and for 3 minutes at high speed to obtain a dough (the amount of water added to wheat flour when preparing a dough: 56% by weight).

Subsequently, the thus obtained dough was mixed at low speed while adding 27.0 kg of water little by little thereto, 4.11 kg of water, 5.17 kg of soybean sirasimeyu (refined soybean oil), 0.45 kg of emulsified fat and oil, and 6.78 kg of starch syrup were added thereto, and the mixture was mixed at high speed to obtain a batter. The resulting batter was baked in a baking drum (HT-45, Daiei Engineering Co., Ltd.) to obtain band-like spring roll wrappers. The resulting bands were cut using a cutter knife to prepare spring roll wrappers with a size of approximately 21 cm×21 cm and a weight of 23 g.

### <Production Method B: A Conventional Method>

Water (73.28 kg), 1.29 kg of salt, 0.87 kg of baking powder, 5.17 kg of soybean sirasimeyu (refined soybean oil), and 15.09 kg of starch syrup were introduced into a mixer (KS200, Tokyo Sangyo Co., Ltd.) and mixed.

Subsequently, 75 kg of wheat flour was added with mixing at low speed, and the mixture was mixed at high speed to obtain a batter. The resulting batter was baked and cut in the same manner as described above to prepare spring roll wrappers.

### (2) Preparation of Spring Rolls

In the spring roll wrappers prepared in (1) above (approximately 23 g each), 27 g of fillings were filled, and the wrappers were rolled up in accordance with a conventional technique to prepare spring rolls. Fillings generally used for spring rolls, such as pork, siitake mushroom, bean starch vermicelli, carrot, and seasonings, were used to prepare spring rolls. The resulting spring rolls were subjected to freezing at approximately −35° C. for approximately 1 hour, packaged to prevent drying out, and stored at −18° C.

### (Example 2) Preparation of Spring Roll Wrappers and Spring Rolls

### (1) Preparation of Spring Roll Wrappers

Wheat flour (all-purpose flour, 75 kg), 1.29 kg of salt, and 0.87 kg of baking powder were introduced into a mixer (HM300-140T, Oshikiri Machinery Ltd.) and mixed at low speed. To the resulting mixture, 45.0 kg of water and 8.31 kg of starch syrup were added, and the mixture was mixed for 3 minutes at low speed and for 3 minutes at high speed to obtain a dough (the amount of water added to wheat flour when preparing a dough: 60% by weight).

Subsequently, the thus obtained dough was mixed at low speed while adding 24.17 kg of water little by little thereto, 4.11 kg of water, 5.17 kg of soybean sirasimeyu (refined soybean oil), 0.45 kg of emulsified fat and oil, and 6.78 kg of starch syrup were added thereto, and the mixture was mixed at high speed to obtain a batter. The resulting batter was baked in a baking drum (HT-45, Daiei Engineering Co., Ltd.) to obtain band-like spring roll wrappers. The resulting bands were cut using a cutter knife to prepare spring roll wrappers with a size of approximately 21 cm×21 cm and a weight of 23 g.

### (2) Preparation of Spring Rolls

Spring rolls were prepared with the use of the spring roll wrappers prepared in (1) above in the same manner as in Example 1.

### (Example 3) Preparation of Spring Roll Wrappers and Spring Rolls

### (1) Preparation of Spring Roll Wrappers

Wheat flour (all-purpose flour, 75 kg), 1.29 kg of salt, and 0.87 kg of baking powder were introduced into a mixer (HM300-140T, Oshikiri Machinery Ltd.) and mixed at low speed. To the resulting mixture, 39.75 kg of water and 8.31 kg of starch syrup were added, and the mixture was mixed for 3 minutes at low speed and for 3 minutes at high speed to obtain a dough (the amount of water added to wheat flour when preparing a dough: 53% by weight).

Subsequently, the thus obtained dough was mixed at low speed while adding 29.42 kg of water little by little thereto, 4.11 kg of water, 5.17 kg of soybean sirasimeyu (refined soybean oil), 0.45 kg of emulsified fat and oil, and 6.78 kg of starch syrup were added thereto, and the mixture was mixed at high speed to obtain a batter. The resulting batter was baked in a baking drum (HT-45, Daiei Engineering Co., Ltd.) to obtain band-like spring roll wrappers. The resulting bands were cut using a cutter knife to prepare spring roll wrappers with a size of approximately 21 cm×21 cm and a weight of 23 g.

### (2) Preparation of Spring Rolls

Spring rolls were prepared with the use of the spring roll wrappers prepared in (1) above in the same manner as in Example 1.

### (Test Example 1) Evaluation of Physical Properties of Spring Roll Wrappers

(1) A degree of polymerization of a gluten protein

The spring roll wrappers of Example 1 (26 test specimens), the spring roll wrappers of Example 2 (10 test specimens), the spring roll wrappers of Example 3 (10 test specimens), and the spring roll wrappers of Comparative Example 1 (33 test specimens) were freeze-dried, crushed, and then subjected to measurement of a degree of polymerization of a gluten protein. For measurement of the degree of polymerization, a mercaptoethanol (ME)-containing protein extraction buffer (+ME) and a ME-free protein extraction buffer (−ME) were prepared in advance (see Table 2).

TABLE 2
Composition of protein extraction buffer

| | | |
|---|---|---|
| Reagent | Amount collected (mL) | Total amount (mL) |

Buffer (+ME)

| | | |
|---|---|---|
| 5% SDS solution | 10.00 | 100.00 |
| 0.5M Tris-HCl | 10.00 | |
| buffer (pH 6.8) | | |
| 2-Mercaptoethanol | 1.00 | |
| (ME) | | |
| Distilled water | 79.00 | |

Buffer (−ME)

| | | |
|---|---|---|
| 5% SDS solution | 10.00 | 100.00 |
| 0.5M Tris-HCl | 10.00 | |
| buffer (pH 6.8) | | |
| Distilled water | 80.00 | |

A sample (100 mg) was introduced into each of two 2-mL Eppendorf tubes, 1 mL of a buffer (−ME) was added to a first tube, 1 mL of a buffer (+ME) was added to a second tube, and the contents of the tubes were mixed using a vortex mixer until the contents were completely dissolved. Thereafter, the tubes were agitated in an agitator (about 2,000 rpm) for 1 hour and centrifuged at 6,200 rpm and room temperature for 10 minutes. The supernatants were then transferred to other Eppendorf tubes.

The amount of the proteins in the solutions was measured by the Lowry method using the RCDC protein assay kit (Bio-Rad). The degree of polymerization was determined in accordance with the equation indicated below by designating the amount of the protein quantified using the buffer (+ME) as the (+ME) protein and the amount of the protein quantified using the buffer (−ME) as the (−ME) protein.

Degree of polymerization (%)=((+ME)protein−(−ME) protein)/(+ME) protein×100

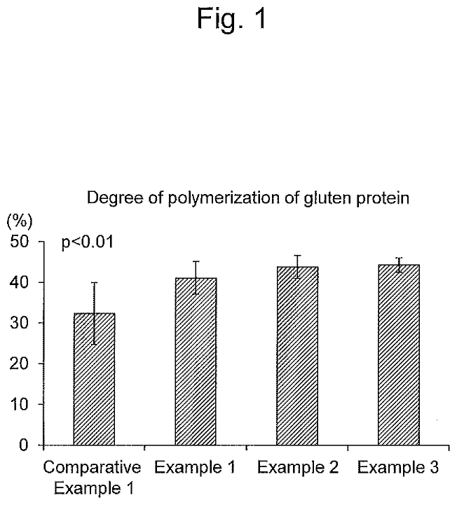

The measured data were subjected to the outlier test. Table 3-1 shows the results of measurement of the degree of polymerization of a gluten protein of the spring roll wrappers of Example 1 and Comparative Example 1, and Table 3-2 shows the results of measurement of the degree of polymerization of a gluten protein of the spring roll wrappers of Example 2 and Example 3. Table 3-3 shows a summary of the mean, the standard deviation (a), and the mean±2σ of the degree of polymerization of a gluten protein of the spring roll wrappers of Examples 1 to 3 and Comparative Example 1. Also, FIG. 1 shows the degree of polymerization of a gluten protein of the spring roll wrappers of Examples 1 to 3 and Comparative Example 1 (the mean of the test specimens).

TABLE 3-1
Results of measurement of degree of polymerization
of gluten protein (Part 1)

| | Comparative Example 1 | | | Example 1 | | |
|---|---|---|---|---|---|---|
| | | | Degree of | | | Degree of |
| | | | polymerization | | | polymerization |
| No. | ME− | ME+ | (%) | ME− | ME+ | (%) |
| 1 | 23.68 | 38.89 | 39.10 | 23.87 | 44.11 | 45.89 |
| 2 | 22.83 | 34.17 | 33.20 | 27.62 | 43.12 | 35.95 |
| 3 | 34.43 | 53.94 | 36.18 | 36.37 | 65.68 | 44.63 |
| 4 | 29.82 | 46.77 | 36.24 | 35.35 | 56.91 | 37.89 |
| 5 | 34.23 | 41.38 | 17.29 | 24.33 | 43.31 | 43.81 |
| 6 | 24.39 | 39.07 | 37.59 | 27.03 | 41.76 | 35.28 |
| 7 | 22.75 | 27.89 | 18.43 | 35.96 | 68.19 | 47.27 |
| 8 | 34.22 | 59.48 | 42.47 | 33.77 | 54.48 | 38.00 |
| 9 | 31.53 | 52.88 | 40.36 | 25.13 | 43.07 | 41.67 |
| 10 | 29.47 | 38.04 | 22.53 | 11.73 | 22.12 | 47.00 |
| 11 | 13.72 | 19.36 | 29.13 | 29.60 | 52.25 | 43.35 |
| 12 | 24.67 | 41.47 | 40.52 | 28.01 | 41.70 | 32.85 |
| 13 | 30.16 | 44.06 | 31.55 | 29.90 | 48.20 | 37.97 |
| 14 | 28.94 | 39.72 | 27.15 | 29.08 | 47.46 | 38.72 |
| 15 | 27.54 | 45.75 | 39.82 | 28.62 | 46.55 | 38.50 |
| 16 | 27.52 | 34.61 | 20.49 | 36.21 | 59.87 | 39.51 |
| 17 | 33.45 | 47.45 | 29.50 | 35.76 | 57.94 | 38.28 |
| 18 | 30.32 | 42.07 | 27.93 | 35.84 | 57.44 | 37.61 |
| 19 | 26.23 | 45.28 | 42.07 | 37.57 | 61.54 | 38.95 |
| 20 | 27.80 | 37.20 | 25.28 | 32.80 | 54.96 | 40.31 |
| 21 | 29.36 | 46.71 | 37.14 | 35.36 | 59.65 | 40.71 |
| 22 | 28.24 | 40.96 | 31.07 | 18.35 | 34.84 | 47.34 |
| 23 | 34.77 | 48.95 | 28.96 | 19.36 | 33.63 | 42.43 |
| 24 | 34.17 | 46.41 | 26.38 | 19.69 | 34.71 | 43.26 |
| 25 | 33.62 | 47.91 | 29.83 | 17.27 | 32.01 | 46.05 |
| 26 | 33.16 | 48.21 | 31.22 | 18.15 | 32.99 | 44.97 |
| 27 | 33.23 | 44.21 | 24.84 | | | |
| 28 | 33.69 | 46.89 | 28.16 | | | |
| 29 | 27.10 | 45.66 | 40.65 | | | |
| 30 | 28.56 | 38.62 | 26.06 | | | |
| 31 | 29.38 | 46.31 | 36.55 | | | |
| 32 | 27.04 | 49.58 | 45.45 | | | |
| 33 | 26.09 | 46.26 | 43.60 | | | |
| Mean | 28.97 | 43.22 | 32.32 | 28.18 | 47.63 | 41.08 |
| Standard | 4.55 | 7.50 | 7.58 | 7.32 | 11.71 | 4.02 |
| deviation | | | | | | |

TABLE 3-2
Results of measurement of degree of polymerization
of gluten protein (Part 2)

| | Example | Example |
|---|---|---|
| No. | 2 | 3 |
| 1 | 45.17 | 45.46 |
| 2 | 46.75 | 43.80 |
| 3 | 35.64 | 41.89 |
| 4 | 39.10 | 38.58 |
| 5 | 50.97 | 49.43 |
| 6 | 53.56 | 48.18 |
| 7 | 38.63 | 42.36 |
| 8 | 41.52 | 44.07 |
| 9 | 42.75 | 43.51 |
| 10 | 43.11 | 44.82 |
| Mean (%) | 43.72 | 44.21 |
| Standard deviation | 5.57 | 3.09 |

TABLE 3-3
Results of measurement of degree of polymerization
of gluten protein (summary)

| | Comparative | Example | Example | Example |
|---|---|---|---|---|
| | Example 1 | 1 | 2 | 3 |
| Mean (%) | 32.32 | 41.08 | 43.72 | 44.21 |
| Standard deviation | 7.58 | 4.02 | 5.57 | 3.09 |
| Mean − 2σ (%) | 17.17 | 33.04 | 32.58 | 38.03 |
| Mean + 2σ (%) | 47.48 | 49.13 | 54.86 | 50.39 |

As shown in Table 3-3, the degree of polymerization of a gluten protein of the spring roll wrappers of Examples 1 to 3 (the products of the present invention) was greater than the degree of polymerization of a gluten protein of the spring roll wrapper of Comparative Example 1 (the conventional product), and the degree of polymerization of a gluten protein of the spring roll wrapper of the present invention was determined to be 32.00% or higher as a result of the calculation: the mean−2σ. As shown in FIG. 1, a significant difference (p<0.01) was detected in Examples 1, 2, and 3 relative to Comparative Example 1 as a result of the Tukey test.

### (2) Breaking Strength

### (Method of Measurement)

The spring roll wrappers of Examples 1 to 3 and Comparative Example 1 were used as samples. The 8 sheets of the sample spring roll wrappers (12 test specimens each) were stacked (thickness of each sheet: 0.5 mm to 0.7 mm, the total thickness of the stacked 8 sheets: 4.0 mm to 5.6 mm), the resultants were cut into rectangular pieces of approximately 3 cm×4.5 cm, and the middle regions thereof were subjected to measurement to determine the breaking strength. The breaking strength was determined by measuring the maximal load (N) with the use of a creep meter (CR-200D, Sun Scientific Co., Ltd.) with a wedge plunger (width: 2 cm) at the moving speed of 60 mm/min, the penetration distance of 13 mm, and the clearance of 2 mm. The conditions for the measurement of the breaking strength were temperature of 25° C. and relative humidity of 57%.

### (Results of Measurement)

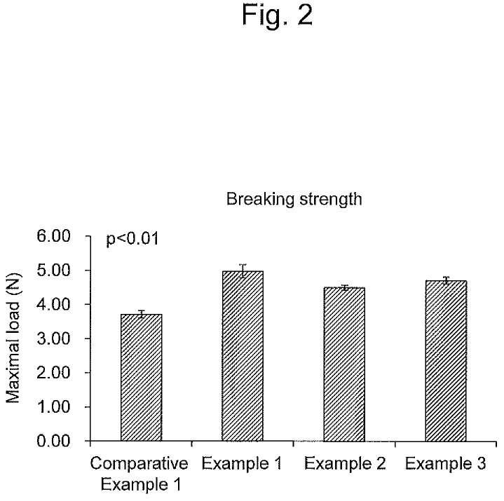

The measured data were subjected to the outlier test. Table 4-1 shows the results of measurement of the breaking strength of the spring roll wrappers of Examples 1 to 3 and Comparative Example 1, and Table 4-2 shows a summary of the mean, the standard deviation (σ), and the mean±2σ of the breaking strength of the spring roll wrappers of Examples 1 to 3 and Comparative Example 1. Also, FIG. 2 shows the breaking strength of the spring roll wrappers of Examples 1 to 3 and Comparative Example 1 (the mean of the test specimens).

TABLE 4-1
Results of measurement of breaking strength

| | Maximal load (N) | | | |
|---|---|---|---|---|
| | Comparative | Example | Example | Example |
| No. | Example 1 | 1 | 2 | 3 |
| 1 | 3.80 | 4.70 | 4.56 | 4.77 |
| 2 | 3.79 | 4.73 | 4.62 | 4.75 |
| 3 | 3.60 | 4.79 | 4.52 | 4.81 |
| 4 | 3.91 | 4.94 | 4.49 | 4.95 |
| 5 | 3.67 | 4.94 | 4.64 | 4.68 |
| 6 | 3.80 | 5.14 | 4.57 | 4.61 |
| 7 | 3.59 | 4.86 | 4.53 | 4.73 |
| 8 | 3.80 | 5.14 | 4.45 | 4.83 |
| 9 | 3.71 | 4.93 | 4.58 | 4.71 |
| 10 | 3.66 | 5.33 | 4.46 | 4.77 |
| 11 | 3.58 | 5.08 | 4.45 | 4.61 |
| 12 | 3.65 | 5.14 | 4.41 | 4.62 |
| Mean (N) | 3.71 | 4.98 | 4.52 | 4.74 |
| Standard deviation | 0.11 | 0.19 | 0.07 | 0.10 |

TABLE 4-2
Results of measurement of breaking strength (summary)

| | Comparative | Example | Example | Example |
|---|---|---|---|---|
| | Example 1 | 1 | 2 | 3 |
| Mean (N) | 3.71 | 4.98 | 4.52 | 4.74 |
| Standard deviation | 0.11 | 0.19 | 0.07 | 0.10 |
| Mean − 2σ (N) | 3.50 | 4.59 | 4.38 | 4.53 |
| Mean + 2σ (N) | 3.93 | 5.36 | 4.67 | 4.94 |

As shown in Table 4-2, the breaking strength of the spring roll wrappers of Examples 1 to 3 (the products of the present invention) was greater than the breaking strength of the spring roll wrapper of Comparative Example 1 (the conventional product), and the breaking strength of the spring roll wrapper of the present invention was determined to be 4.30 N or higher as a result of the calculation: the mean−2σ. As shown in FIG. 2, a significant difference (p<0.01) was detected in Examples 1, 2, and 3 relative to Comparative Example 1 as a result of the Tukey test.

### (3) Tensile Strength

### (Method of Measurement)

The spring roll wrappers of Example 1 and Comparative Example 1 were used as samples. The 2 sheets of the sample spring roll wrappers (the spring roll wrappers of Example 1: 11 test specimens; and the spring roll wrappers of Comparative Example 1: 12 test specimens) were stacked, the resultant was cut into rectangular pieces of approximately 1.5 cm×5 cm, and the both ends thereof were fixed with adaptors for tensile strength measurement to determine the tensile strength. The tensile strength was determined by measuring the maximal tensile load (N) with the use of a creep meter (CR-200D, Sun Scientific Co., Ltd.) and noodle tensile strength-type adaptors (Adaptor 21, SUN RHEOMETER) at the moving speed of 120 mm/min and the moving distance of 25 mm in the extension direction. The conditions for the measurement of the tensile strength were temperature of 25° C. and relative humidity of 57%.

### (Results of Measurement)

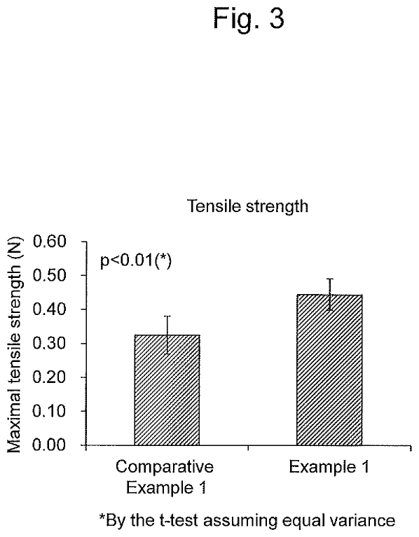

The measured data were subjected to the outlier test. Table 5-1 shows the results of measurement of the tensile strength of the spring roll wrappers of Example 1 and Comparative Example 1, and Table 5-2 shows a summary of the mean, the standard deviation (σ), and the mean±2σ of the tensile strength of the spring roll wrappers of Example 1 and Comparative Example 1. Also, FIG. 3 shows the tensile strength of the spring roll wrappers of Example 1 and Comparative Example 1 (the mean of the test specimens).

TABLE 5-1
Results of measurement of tensile strength

Tensile strength

| | Comparative | Example |
|---|---|---|
| No. | Example 1 | 1 |
| 1 | 0.35 | |
| 2 | 0.39 | 0.50 |
| 3 | 0.43 | 0.45 |
| 4 | 0.38 | 0.50 |
| 5 | 0.28 | 0.49 |
| 6 | 0.26 | 0.41 |
| 7 | 0.27 | 0.38 |
| 8 | 0.25 | 0.38 |
| 9 | 0.30 | 0.46 |
| 10 | 0.31 | 0.48 |
| 11 | 0.34 | 0.39 |
| 12 | 0.34 | 0.45 |
| Mean (N) | 0.33 | 0.44 |
| Standard deviation | 0.06 | 0.05 |

TABLE 5-2
Results of measurement of tensile strength (summary)

| | Comparative | Example |
|---|---|---|
| | Example 1 | 1 |
| Mean (N) | 0.33 | 0.44 |
| Standard deviation | 0.06 | 0.05 |
| Mean − 2σ (N) | 0.21 | 0.35 |
| Mean + 2σ (N) | 0.44 | 0.54 |

As shown in Table 5-2, the tensile strength of the spring roll wrapper of Example 1 (the product of the present invention) was greater than the tensile strength of the spring roll wrapper of Comparative Example 1 (the conventional product), and the tensile strength of the spring roll wrapper of the present invention was determined to be 0.34 N or higher as a result of the calculation: the mean−2σ. As shown in FIG. 3, the t-test assuming equal variance revealed a significant difference (p<0.01) in Comparative Example 1 and Example 1.

### (Test Example 2) Sensory Evaluation of Spring Rolls

The spring rolls prepared and cryopreserved in Examples 1 to 3 and Comparative Example 1 were deep fried in soybean sirasimeyu (refined soybean oil) at 175° C. for 5 minutes. The deep-fried spring rolls were introduced into perforated bags (SA-20 (V), FP Corporation) at 3 rolls/bag and then stored in an incubator (PL-2KP, Tabai; temperature: 23° C.; humidity: 50%) for 2 or 4 hours.

The fried spring rolls immediately after deep frying and the fried spring rolls after storage were subjected to sensory evaluation in terms of “crispness.” Evaluation was performed by 5 expert panelists. The crispness of the fried spring rolls prepared with the use of the spring roll wrappers of Comparative Example 1 (the conventional product) after storage was designated as 3.0, the crispness immediately after deep frying was designated as 5.0, and the fried spring rolls after storage were scored on a scale of 1.0 (not crispy) to 5.0 (crispy). Table 6 shows the results of evaluation.

TABLE 6

| | | Example | Example | Example | Comparative |
|---|---|---|---|---|---|
| | | 1 | 2 | 3 | Example 1 |
| Amount of water | | 56 | 60 | 53 | — |
| added to wheat | | | | | |
| flour when | | | | | |
| preparing | | | | | |
| dough (wt %) | | | | | |
| Storage | 2 hours | 4.0 | 4.1 | 4.0 | 3.0 |
| time | 4 hours | 4.0 | 3.8 | 3.8 | 3.0 |

As shown in Table 6, crispness of the fried spring rolls prepared with the use of the spring roll wrappers of Comparative Example 1 after storage for 4 hours was scored 3.0, that of the fried spring rolls prepared with the use of the spring roll wrappers of Example 1 was scored 4.0, and that of the fried spring rolls prepared with the use of the spring roll wrappers of Examples 2 and 3 was scored 3.8. That is, crispness of the fried spring rolls prepared with the use of the spring roll wrappers of Examples 1 to 3 was maintained 4 hours after deep frying.

### INDUSTRIAL APPLICABILITY

The present invention can be used in the field of preparation of a rolled food, such as a spring roll.

All publications, patents, and patent applications cited herein are incorporated herein by reference in their entirety.

1. An outer wrapper for a rolled food baked before rolling, having the features (A) and (B):
(A) a gluten protein in the outer wrapper has a degree of polymerization of 32.00% or higher; and
(B) an outer wrapper composed of 8 sheets each having a size of 3 cm×4.5 cm stacked on one another exhibits a breaking strength of 4.30 N or higher, which is measured using a creep meter with a wedge plunger (width: 2 cm) at a moving speed of 60 mm/min and a penetration distance of 13 mm.

2. The outer wrapper for the rolled food according to claim 1, further having the feature (C):
(C) an outer wrapper composed of 2 sheets each having a size of 1.5 cm×5 cm stacked on each other exhibits a tensile strength of 0.34 N or higher, which is measured using a creep meter at a moving speed of 120 mm/min and a moving distance of 25 mm in the extension direction.

3. The outer wrapper for the rolled food according to claim 1, wherein the rolled food is a spring roll and the outer wrapper is a spring roll wrapper.

4. A rolled food comprising fillings wrapped in the outer wrapper for the rolled food according to claim 1.

5. The rolled food according to claim 4, which is deep-fried.

6. The rolled food according to claim 4, which is frozen.

7. The rolled food according to claim 4, wherein the rolled food is a spring roll and the outer wrapper is a spring roll wrapper.

8. A method for producing an outer wrapper for a rolled food comprising the following steps:
(1) a step of adding water and salt to a powdery raw material mainly composed of wheat flour and kneading the mixture to prepare a dough;
(2) a step of adding water to the dough to prepare a batter; and
(3) a step of baking the batter.

9. The method for producing an outer wrapper for a rolled food according to claim 8, wherein the rolled food is a spring roll and the outer wrapper is a spring roll wrapper.

10. A method for producing a rolled food comprising a step of placing fillings on the outer wrapper for the rolled food obtained by the method according to claim 8 and rolling up the outer wrapper to form a rolled food.

11. The method for producing a rolled food according to claim 10, which further comprises a step of deep frying.

12. The method for producing a rolled food according to claim 10, which further comprises a step of freezing.

13. The method for producing a rolled food according to claim 10, wherein the rolled food is a spring roll and the outer wrapper is a spring roll wrapper.
